(19) United States
(12) Patent Application Publication
(10) Pub. No.: US 2016/0049865 A1
(43) Pub. Date: Feb. 18, 2016

(54) FAST START-UP CIRCUIT OF A FLYBACK POWER SUPPLY AND METHOD THEREOF

(71) Applicant: Richtek Technology Corp., Zhubei City (TW)

(72) Inventors: Jyun-Che HO, Xikou Township (TW); Tzu-Chen LIN, Tianzhong Township (TW); Isaac Y. CHEN, Jubei City (TW); Yi-Wei LEE, Taipei City (TW)

(21) Appl. No.: 14/809,699

(22) Filed: Jul. 27, 2015

(30) Foreign Application Priority Data
Aug. 15, 2014 (TW) 103128133

(51) Int. Cl. H02M 1/36; H02M 3/335

(52) U.S. Cl. CPC H02M 1/36; H02M 3/33507

(57) ABSTRACT

A fast start-up circuit and a method of a flyback power supply utilize a charging current that is related to an input voltage of the flyback power supply to charge a control terminal of a power switch of the flyback power supply during a start-up mode. Accordingly, the power switch can be switched, and a supply voltage of the flyback power supply rises. When an output terminal of the flyback power supply occurs a short circuit, the fast start-up circuit and the method of the present invention will decrease a maximum of a current through the power switch, thereby avoiding that the power switch is overheating.

### FIELD OF THE INVENTION

The present invention is generally related to a flyback power supply and, more particularly, to a fast start-up circuit of the flyback supply and a method thereof.

### BACKGROUND OF THE INVENTION

FIG. 1 shows a conventional flyback power supply. When the flyback power supply is just connected to a power source Vac, a supply voltage VCC is not enough such that a controller 10 of the flyback power supply is unable to provide a control signal to switch the power switch Q1. At this time, the flyback power supply is in a start-up mode. During the start-up mode, a starting unit 16 of the flyback power supply determines a charging current Ist according to an input voltage Vin on an input terminal 12 of the flyback power supply. The charging current Ist charges a control terminal of the power switch Q1, so that a voltage Vg of the control terminal rises. As shown by a waveform 20 in FIG. 2, when the voltage Vg rises to a preset value, the power switch Q1 is turned on. Accordingly, an auxiliary coil Laux of a transformer TX1 generates a current Iaux to charge a capacitor Cvcc, thereby raising the supply voltage VCC as shown by a waveform 22 in FIG. 2. When the power switch Q1 is turned on, a current Ip through the power switch Q1 rises, and accordingly a first sensing signal Vcs on a sensing resistor Rcs also rises. When the first sensing signal Vcs rises and reaches a predetermined current limit threshold, a sensing circuit 18 of the controller 10 turns on a first switch SW1, and accordingly the voltage Vg is zeroed for turning off the power switch Q1 as shown in FIG. 3. As shown by the waveform 20 in FIG. 2, the start-up unit 16 charges the control terminal of the power switch Q1, so that the power switch Q1 is switched and the supply voltage VCC rises. When the supply voltage VCC rises and reaches the preset value, the controller 10 is start-up, and the flyback power supply enters a normal operation mode. FIG. 4 shows the sensing circuit 18 of FIG. 3. Wherein, resistors R1 and R2 divide the voltage Vg to generate a current limit threshold Vth. A comparator 28 compares the first sensing signal Vcs with the current limit threshold Vth. When the first sensing signal Vcs reaches the current limit threshold Vth, the comparator 28 provides a signal to a deglitch circuit 26 for turning on the first switch SW1. A low dropout (LDO) 24 generates an adequate voltage to the deglitch circuit 26 and the comparator 28 according to the voltage Vg for being served as the power.

The start-up time of such conventional start-up method is related to the power source Vac. The higher the voltage value of the power source Vac is, the greater the charging current Ist will be, and the shorter the start-up time will be. However, when the output terminal 14 of the flyback power supply is short to the ground, the supply voltage VCC will be maintained at a lower level, which means that the power VCC cannot reach the preset value. Consequently, the start-up unit 16 lets the power switch Q1 keep switching, so that the temperature of the power switch Q1 rises. Moreover, the higher the voltage value of the power source Vac is, and the higher the temperature of the power switch Q1 will be. Whereby, a higher power source Vac easily results in an overheating power switch Q10, and thence the power switch Q1 will be damaged. Accordingly, it needs trade-off between start-up time and thermal issue in such conventional start-up method.

Therefore, it is desired a fast start-up method that achieves a fast start-up but gets rid of the thermal issue.

### SUMMARY OF THE INVENTION

An object of the present invention is to provide a fast start-up circuit of a flyback power supply and a method thereof to achieve a fast start-up but gets rid of a thermal issue.

According to the present invention, a fast start-up circuit of a flyback power supply comprises a start-up unit and a current limit circuit. During a start-up mode, the start-up unit provides a charging current that is related to an input voltage of the flyback power supply to charge a control terminal of a power switch of the flyback power supply, thereby switching the power switch and raising a supply voltage of the flyback power supply. when an output terminal of the flyback power supply occurs a short circuit, the current limit circuit lowers a maximum of a current through the power switch in order to decrease a temperature of the power switch, thereby avoiding that the power switch is overheating.

According to the present invention, a fast start-up method of the flyback power supply provides the charging current that is related to the input voltage of the flyback power supply to charge the control terminal of the power switch of the flyback power supply during a start-up mode, thereby switching the power switch and raising the supply voltage of the flyback power supply. When the output terminal of the flyback power supply occurs a short circuit, the maximum of the current of the power switch will be lowered for decreasing the temperature of the power switch, thereby avoiding that the power switch is overheating.

### BRIEF DESCRIPTION OF THE DRAWINGS

These and other objectives, features and advantages of the present invention will become apparent to those skilled in the art upon consideration of the following description of the preferred embodiments according to the present invention taken in conjunction with the accompanying drawings, in which:

FIG. 1 shows a conventional flyback power supply;

FIG. 2 shows waveforms of the signals in FIG. 1;

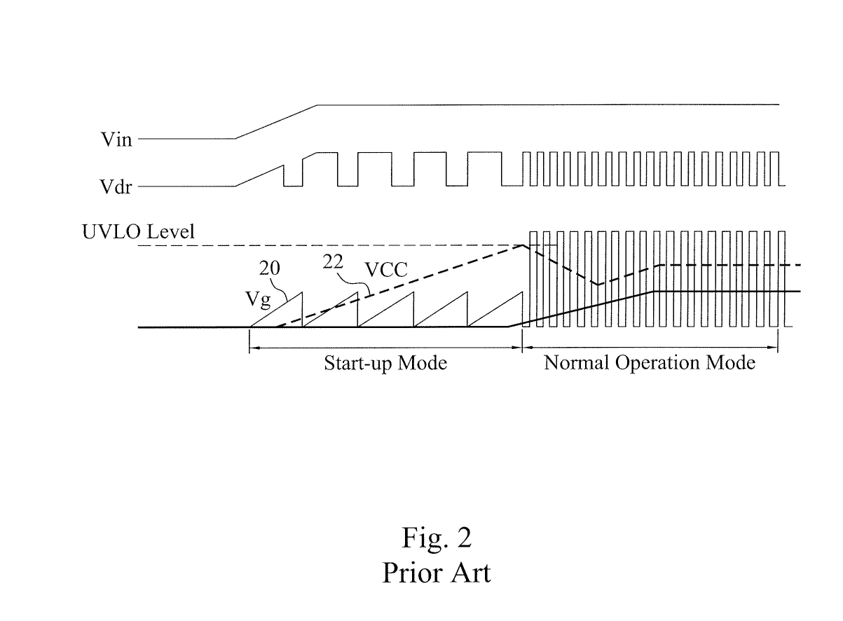

FIG. 3 shows the controller in FIG. 1;

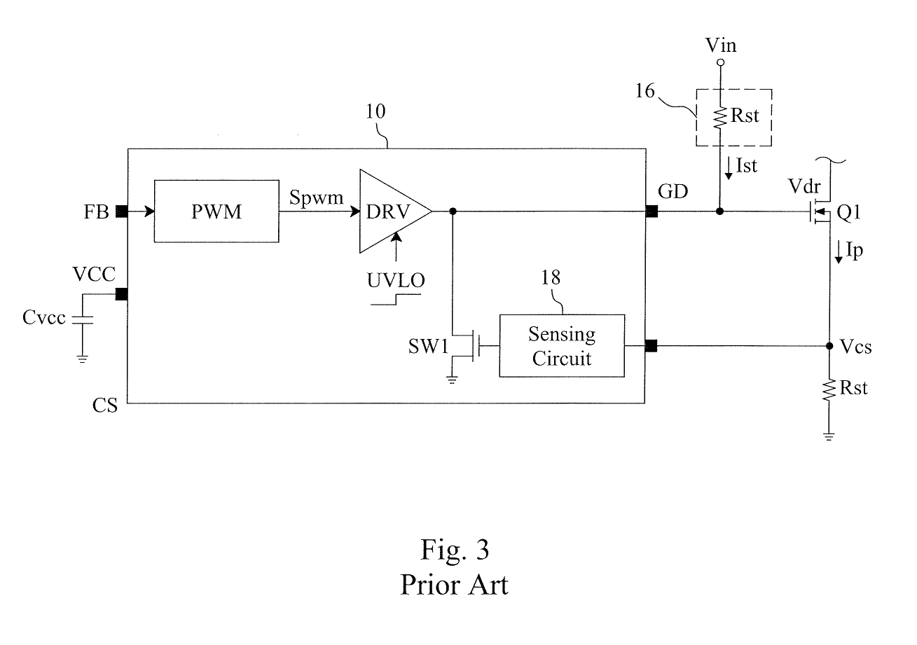

FIG. 4 shows the sensing circuit in FIG. 3;

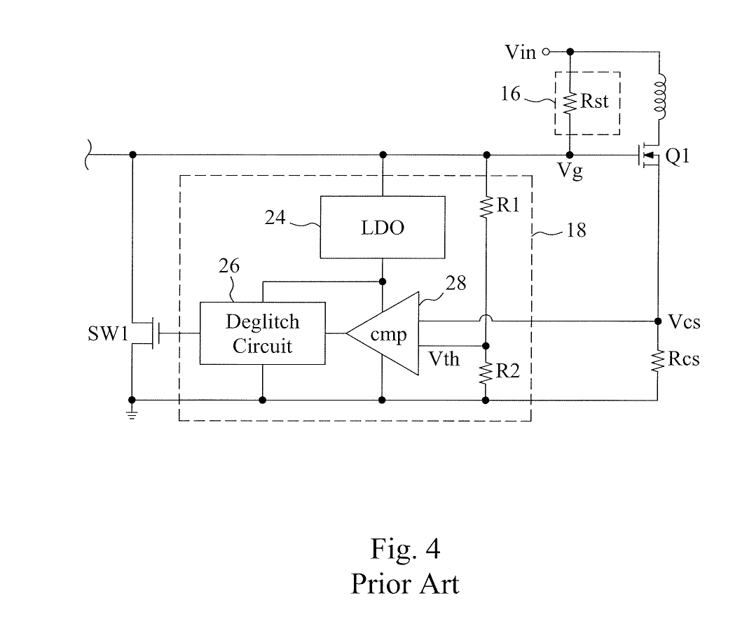

FIG. 5 shows a fast start-up circuit of a flyback power supply of the present invention;

FIG. 6 shows a first embodiment of the current limit circuit in FIG. 5;

FIG. 7 shows the current limit threshold Vth_cs which rises in accordance with a rising of the supply voltage VCC;

FIG. 8 shows a second embodiment of the current limit circuit in FIG. 5;

FIG. 9 shows a third embodiment of the current limit circuit in FIG. 5; and

FIG. 10 shows a embodiment of the offset control circuit in FIG. 9.

### DETAILED DESCRIPTION OF THE INVENTION

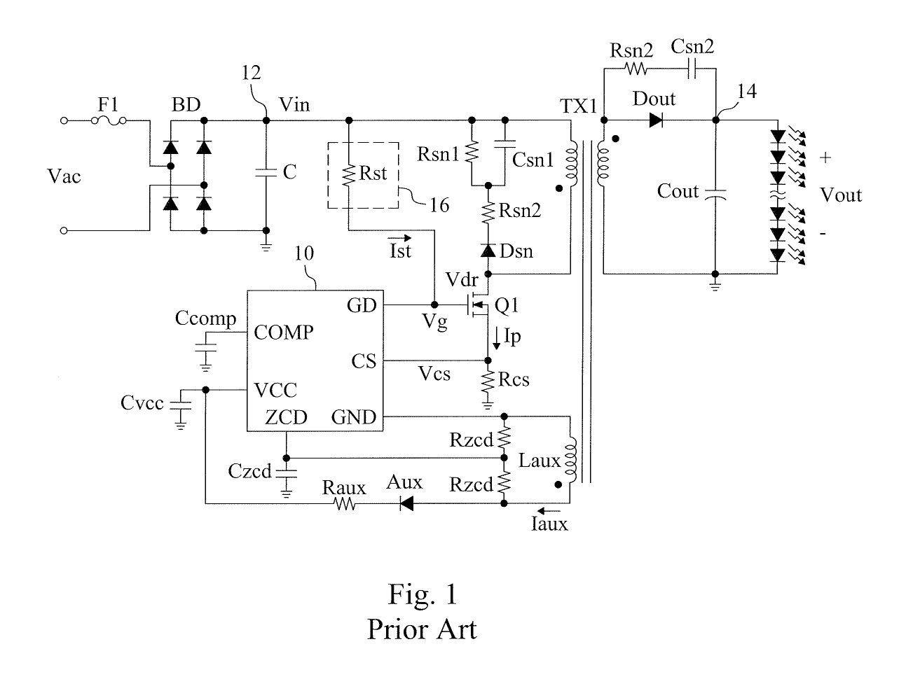

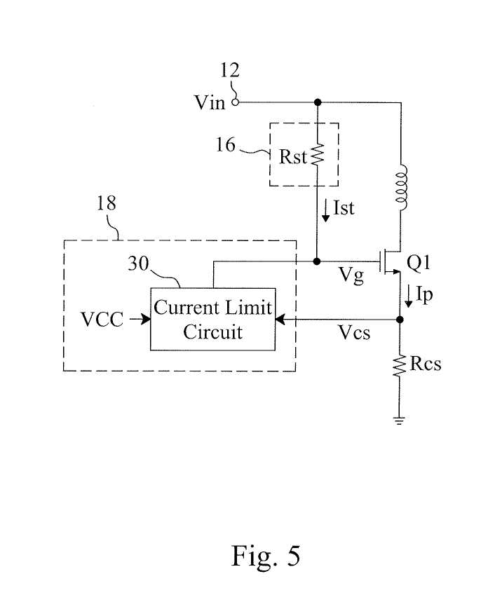

Referring to FIG. 5, a fast start-up circuit of a flyback power supply is shown. The flyback power supply comprises a start-up unit 16 and a current limit circuit 30. In order to convenient illustrate, FIG. 5 does not show a complete configuration of the flyback power supply; the complete configuration of the flyback power supply can refer to FIG. 1. During a start-up mode, the start-up unit 16 generates a charging current Ist according to an input voltage Vin of an input terminal 12 of the flyback power supply to charges a control terminal of a power switch Q1. When a voltage Vg of the control terminal of the power switch Q1 reaches a preset value, the power switch Q1 will be turned on. When the power switch Q1 is turned on, a current Ip flows through a sensing resistor Rcs that is serially connected to the power switch Q1 to generate a first sensing signal Vcs. The current limit circuit 30 detects the first sensing signal Vcs, and when the first sensing signal Vcs reaches a current limit threshold, the current limit circuit 30 turns off the power switch Q1. When the output terminal 14 of the flyback power supply (as shown in FIG. 1) occurs a short circuit, the current limit circuit 30 lowers a maximum of the current Ip through the power switch Q1. Wherein, the temperature of the power switch Q1 is related to the maximum of the current Ip through the power switch Q1. Accordingly, lowering the maximum of the current Ip can decrease the temperature of the power switch Q1, thereby avoiding that the power switch Q1 is overheating as well as avoiding that power switch Q1 is damaging. In this embodiment, the current limit circuit 30 judges whether the output terminal 14 of the flyback power supply occurs the short circuit or not according to the supply voltage VCC. When the output terminal 14 of the flyback power supply occurs the short circuit, the supply voltage VCC decreases to 0V. Namely, the current limit circuit 30 can control the maximum of the current Ip according to the variation of the supply voltage VCC.

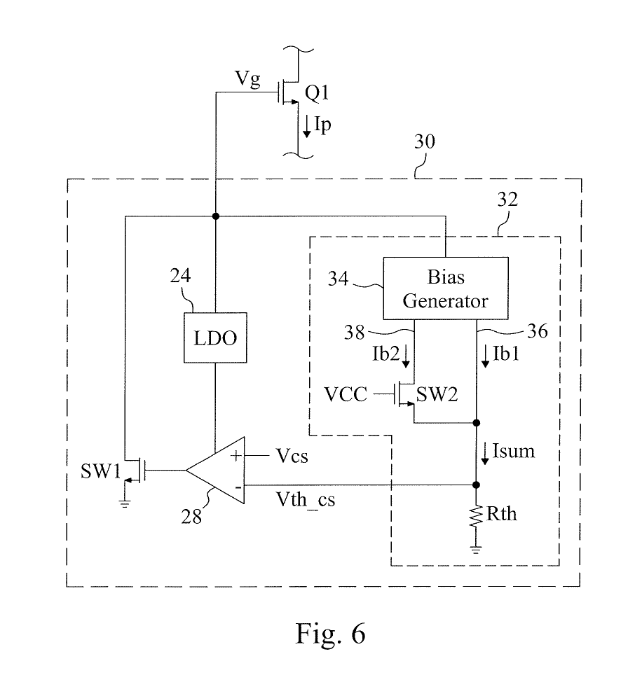

FIG. 6 shows a first embodiment of the current limit circuit 30 in FIG. 5. The current limit circuit 30 comprises a first switch SW1, a low dropout 24, a comparator 28, and a threshold generator 32. The low dropout 24 provides a voltage for serving as a power of the comparator 28. The threshold generator 32 provides a current limit threshold Vth_cs that is controlled by the supply voltage VCC. The comparator 28 compares the first sensing signal Vcs with the current limit threshold Vth_cs. When the first sensing signal Vcs reaches the current limit threshold Vth_cs, the comparator 28 turns on the first switch SW1, so that the control terminal of the power switch Q1 is connected to a ground, thereby turning off the power switch Q1 for determining the maximum of the current Ip. The threshold generator 32 includes a threshold value resistor Rth, a second switch SW2, and an bias generator 34. Wherein, the threshold value resistor Rth generates the current limit threshold Vth_cs according to the current Isum thereon. The bias generator 34 includes a first output terminal 36 providing a first offset current Ib1 to the threshold value resistor Rth and a second output terminal 38 providing a second offset current Ib2. The second switch SW2 connects between the second output terminal 38 and the threshold value resistor Rth of the bias generator 34. The second switch SW2 is controlled by the supply voltage VCC. When the supply voltage VCC is below a preset value, the second switch SW2 is turned off. At this time, the current Isum on the threshold value resistor Rth equals the first offset current Ib1. Since the current limit threshold Vth_cs is lower at this time, the maximum of the current Ip will be lower. When the supply voltage VCC is higher than the preset value, the second switch SW2 is turned on. At this time, the current Isum on the threshold value resistor Rth equals the first offset current Ib1 plus the second offset current Ib2. Since the current limit threshold Vth_cs is higher at this time, the maximum of the current Ip will be higher. When the output terminal 14 of the flyback power supply occurs the short circuit, the supply voltage VCC decreases to 0V, and the threshold generator 32 provides a lower current limit threshold Vth_cs to lower the maximum of the current Ip, thereby preventing that the power switch Q1 is overheating.

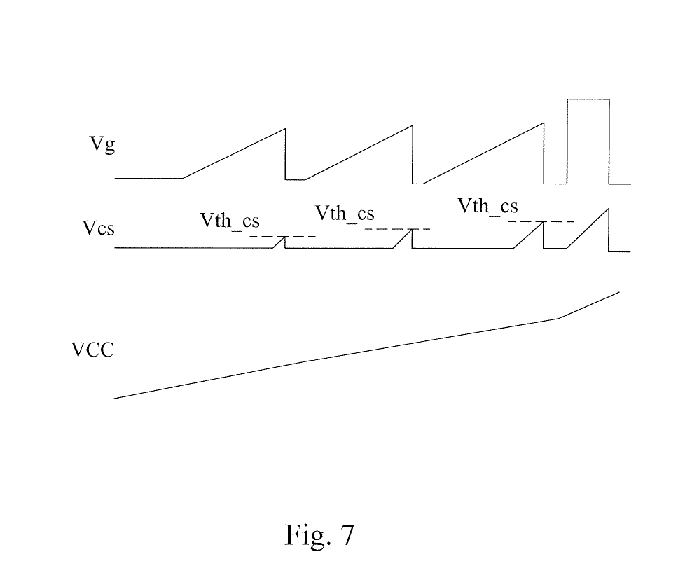

The embodiment shown in FIG. 6 demonstrates that the current limit threshold Vth_cs is switched between two values according to the supply voltage VCC. However, please be noted that the current limit threshold Vth_cs of the present invention is not limited to be switched between two values. Namely, the current limit threshold Vth_cs can be also switched among more than two values according to the supply voltage VCC. Or preferably, the current limit threshold Vth_cs can be linearly proportional to the supply voltage VCC. As shown by the waveform in FIG. 7, the current limit threshold Vth_cs rises in accordance with the ascension of the supply voltage VCC and is linearly direct proportional to the supply voltage VCC.

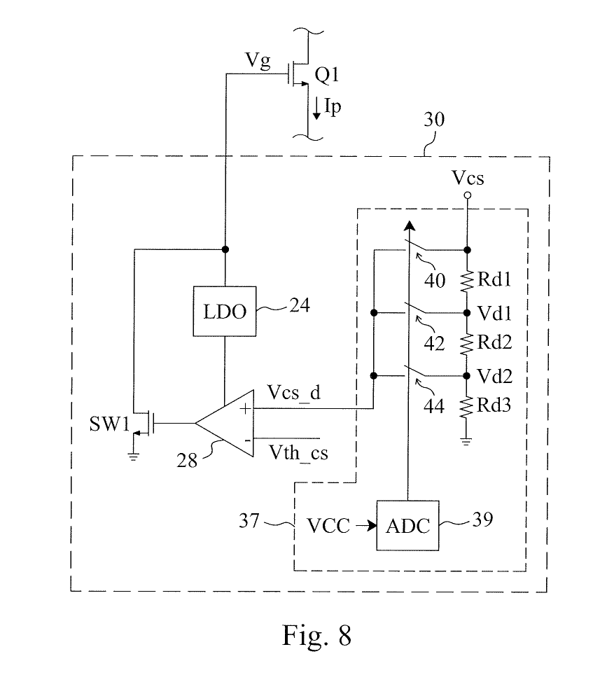

FIG. 8 shows a second embodiment of the current limit circuit 30 in FIG. 5. The current limit circuit 30 includes the first switch SW1, the low dropout 24, the comparator 28, and a voltage divider circuit 37. In this embodiment, the low dropout 24 provides the voltage for serving as the power of the comparator 28. The voltage divider circuit 37 divides the first sensing signal Vcs to generate a second sensing signal Vcs_d. A voltage dividing ratio of the voltage divider circuit 37 is controlled by the supply voltage VCC. The comparator 28 compares the second sensing signal Vcs_d with the current limit threshold Vth_cs. When the second sensing signal Vcs_d reaches the current limit threshold Vth_cs, the comparator 28 turns on the first switch SW1, so that the control terminal of the power switch Q1 is connected to the ground, thereby turning off the power switch Q1 for determining the maximum of the current Ip. In this embodiment, the current limit threshold Vth_cs is a preset fixed value. The voltage divider circuit 37 includes a plurality of resistors Rd1, Rd2, and Rd3, a plurality of switches 40, 42, and 44, and an analog-to-digital converter 39. Wherein, the resistors Rd1, Rd2, and Rd3 divide the first sensing signal Vcs so as to generate a plurality of voltage dividing signals Vd1 and Vd2. The switches 40, 42, and 44 are connected between the resistors Rd1, Rd2, and Rd3 and the comparator 28. The analog-to-digital converter 39 converts the supply voltage VCC into a digital-signal to control the switches 40, 42, and 44 so as to input the first sensing signal Vcs or one of the voltage dividing signals Vd1 and Vd2 to the comparator 28 for serving as the second sensing signal Vcs_d. Namely, the first sensing signal Vcs and the voltage dividing signals Vd1 and Vd2 are both the second sensing signals Vcs_d but with different voltage dividing ratios.

In the embodiment shown in FIG. 8, it is supposed that the resistances of the resistors Rd1, Rd2, and Rd3 are the same. When the supply voltage VCC rises from 0V, the analog-to-digital converter 39 turns on the switch 40 and turns off the switches 42 and 44. At this time, the second sensing signal Vcs_d equals the first sensing signal Vcs, and the maximum of the first sensing signal Vcs equals the current limit threshold Vth_cs. When the supply voltage VCC rises to a first preset value, the analog-to-digital converter 39 turns on the switch 42 and turns off the switches 40 and 44. At this time, the second sensing signal Vcs_d equals Vd1=2/3Vcs, and the maximum of the first sensing signal Vcs equals 3/2Vth_cs. When the supply voltage VCC rises and equals a second preset value, the analog-to-digital converter 39 turns on the switch 44 and turns off the switches 40 and 42. At this time, the second sensing signal Vcs_d equals Vd2=1/3Vcs, and the maximum of the first sensing signal Vcs equals 3×Vth_cs. It is to say, the maximum of the first sensing signal Vcs rises in accordance with the ascension of the supply voltage VCC. Moreover, the first sensing signal Vcs is direct proportional to the current Ip through the power switch Q1. Thus, the maximum of the current Ip also rises in accordance with the ascension of the supply voltage VCC. When the output terminal 14 of the flyback power supply occurs the short circuit, the supply voltage VCC decreases to 0V, and the maximum of the current Ip also descends, thereby avoiding that the power switch Q1 is overheating.

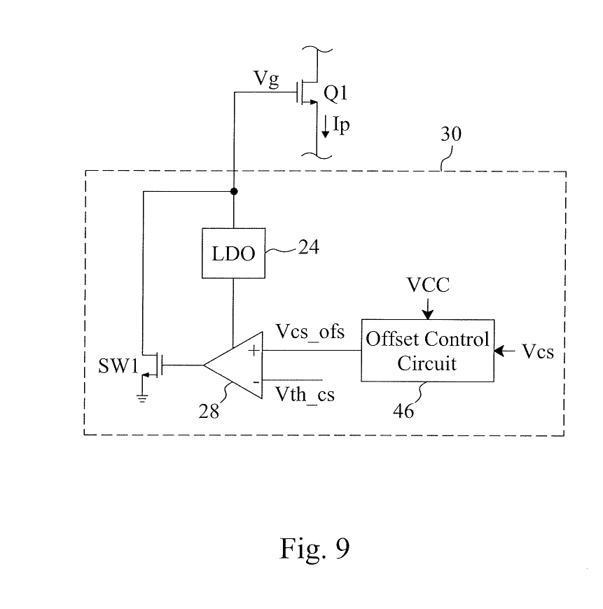

FIG. 9 shows a third embodiment of the current limit circuit 30 in FIG. 5. The current limit circuit 30 includes the first switch SW1, the low dropout 24, the comparator 28, and an offset control circuit 46. In this embodiment, the low dropout 24 provides the voltage for serving as the power of the comparator 28. The offset control circuit 46 determines an offset voltage Voffset (not shown) according to the supply voltage VCC so as to offsets the first sensing signal Vcs and generates the second sensing signal Vcs_ofs. The offset voltage Voffset rises in accordance with the ascension of the supply voltage VCC. The comparator 28 compares the second sensing signal Vcs_ofs with the current limit threshold Vth_cs. The current limit threshold Vth_cs is a preset fixed value. When the second sensing signal Vcs_ofs reaches the current limit threshold Vth_cs, the comparator 28 turns on the first switch SW1 and connects the control terminal of the power switch Q1 to the ground, thereby turning off the power switch Q1 and determining the maximum of the current Ip. When the offset voltage Voffset rises, an initial level of the second sensing signal Vcs_ofs is lower. Accordingly, the time that the second sensing signal Vcs_ofs rises to the current limit threshold Vth_cs increases, so that the maximum of the first sensing signal Vcs also increases. Oppositely, when the offset voltage Voffset decreases, the initial level of the second sensing signal Vcs_ofs is higher. Accordingly, the time that the second sensing signal Vcs_ofs rises to the current limit threshold Vth_cs decreases, so that the maximum of the first sensing signal Vcs decreases. As a result, when the output terminal 14 of the flyback power supply occurs the short circuit, the supply voltage VCC descends to 0V, and the offset control circuit 46 lowers the offset voltage Voffset so as to decrease the maximum of the current Ip, thereby preventing that the power switch Q1 is overheating.

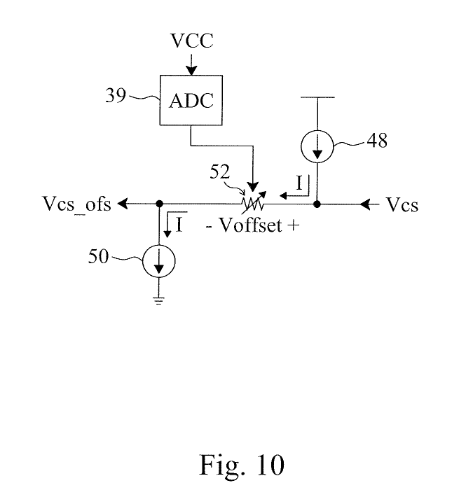

FIG. 10 shows the embodiment of the offset control circuit 46 in FIG. 9. The offset control circuit 46 includes the analog-to-digital converter 39, two current sources 48 and 50, and a variable resistor 52. A first terminal of the variable resistor 52 receives the first sensing signal Vcs from the sensing resistor Rcs. A second terminal of the variable resistor 52 provides the second sensing signal Vcs_ofs to the comparator 28. Two current sources 48 and 50 are respectively connected to the first terminal and the second terminal of the variable resistor 52 so as to provide a fixed current I through the variable resistor 52, thereby generating the offset voltage Voffset. The analog-to-digital converter 39 converts the supply voltage VCC into a digital signal for controlling the resistance of the variable resistor 52. The resistance of the variable resistor 52 decreases in accordance with the ascension of the supply voltage VCC. Accordingly, the offset voltage Voffset on the variable resistor 52 also decreases in accordance with the ascension of the supply voltage VCC.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A fast start-up circuit of a flyback power supply including an input terminal for receiving an input voltage, an output terminal for providing an output voltage, a power switch, and a sensing resistor serially connected to the power switch for providing a first sensing signal, comprising:
a start-up unit connected to a control terminal of the power switch for generating a charging current related to the input voltage of the flyback power supply during a start-up mode of the flyback power supply so as to charge the control terminal of the power switch, thereby switching the power switch and raising a supply voltage of the flyback power supply; and
a current limit circuit connected to the control terminal of the power switch for lowering a maximum of a current through the power switch when the output terminal of the flyback power supply occurs a short circuit, thereby avoiding that the power switch is overheating.

2. The fast start-up circuit of claim 1, wherein the start-up unit comprises a start-up resistor connected between the input terminal of the power supply and the control terminal of the power switch for generating the charging current according to the input voltage.

3. The fast start-up circuit of claim 1, wherein the current limit circuit comprises:
a first switch connected between the control terminal of the power switch and a ground;
a threshold value generator providing a current limit threshold controlled by the supply voltage so as to determine the maximum of the current through the power switch; and
a comparator connected to the sensing resistor, the threshold value generator, and the first switch for comparing the first sensing signal with the current limit threshold and turning on the first switch when the first sensing signal reached the current limit threshold so as to turn off the power switch, thereby limiting the maximum of the current through the power switch;
wherein, when the output terminal of the flyback power supply occurs the short circuit, the threshold value generator reduces the current limit threshold in accordance with a descending of the supply voltage so as to lower the maximum of the current through the power switch.

4. The fast start-up circuit of claim 3, wherein the threshold value generator comprises:
a threshold value resistor generating the current limit threshold according to a current flowing therethrough;
an bias generator having a first output terminal providing a first offset current to the threshold value resistor, and a second output terminal providing a second offset current; and
a second switch connected between the second output terminal of the bias generator and the threshold value resistor and controlled by the supply voltage;
wherein, when the second switch is turned on, the second offset current is provided to the threshold value resistor so as to raise the current limit threshold.

5. The fast start-up circuit of claim 1, wherein the current circuit comprises:
a voltage divider circuit connected to the sensing resistor for dividing the first sensing signal so as to generate a second sensing signal; wherein, a voltage divider ratio of the voltage divider circuit is controlled by the supply voltage;
a first switch connected between the control terminal of the power switch and a reference power terminal; and
a comparator connected to the voltage divider circuit and the first switch for comparing the second sensing signal with a current limit threshold and turned on the first switch when the second sensing signal reaches the current limit threshold so as to turn off the power switch, thereby limiting the maximum of the current through the power switch;
wherein, when the output terminal of the flyback power supply occurs the short circuit, the voltage divider circuit adjusts the voltage divider ratio in accordance with a descending of the supply voltage, thereby lowering the maximum of the current through the power switch.

6. The fast start-up circuit of claim 5, wherein the voltage divider circuit comprises:
a plurality of serially connected resistors for dividing the first sensing signal to generate a plurality of voltage dividing signals;
a plurality of switches connected to the plurality of serially connected resistors and the comparator; and
an analog-to-digital converter connected to the plurality of switches for converting the supply voltage into a digital signal so as to control the plurality of switches, and therefore determining the first sensing signal or one of the voltage dividing signals to be served as the second sensing signal that is input to the comparator.

7. The fast start-up circuit of claim 1, wherein the current limit circuit comprises:
an offset control circuit connected to the sensing resistor for determining an offset voltage according to the supply voltage and offsetting the first sensing signal according to the offset to generate a second sensing signal;
a first switch connected between the control terminal of the power switch and a reference power terminal; and
a comparator connected to the offset control circuit and the first switch for comparing the second sensing signal with a current limit threshold and turning on the first switch when the second sensing signal reaches the current limit threshold so as to turn off the power switch, thereby limiting the maximum of the current through the power switch;
wherein, when the output terminal of the flyback power supply occurs the short circuit, the offset control circuit adjusts the offset voltage in accordance with a descending of the supply voltage, thereby lowering the maximum of the current through the power switch.

8. The fast start-up circuit of claim 7, wherein the offset control circuit includes:
a variable resistor having a first terminal connected to the sensing resistor and a second terminal connected to the comparator;
two current sources respectively connected to the first terminal and the second terminal of the variable resistor for providing a fixed current through the variable resistor so as to generate the offset voltage between the first terminal and the second terminal, wherein the offset voltage is varying with a variation of a resistance of the variable resistor; and
an analog-to-digital converter connected to the variable resistor for converting the supply voltage into a digital signal to control the resistance of the variable resistor

9. A fast start-up method of a flyback power supply including an input terminal for receiving an input voltage, an output terminal for providing an output voltage, a power switch, and a sensing resistor serially connected to the power switch for providing a first sensing signal, comprising the steps of:
(A) generating a charging current related to the input voltage of the flyback power supply during a start-up mode of the flyback power supply so as to charge a control terminal of the power switch, thereby switching the power switch and raising a supply voltage of the flyback power supply; and
(B) lowering a maximum of a current through the power switch when the output terminal of the flyback power occurs a short circuit, thereby avoiding that the power switch is overheating.

10. The fast start-up method of claim 9, wherein the step A comprises setting a start-up resistor between the input terminal of the power supply and the control terminal of the power switch for generating the charging current.

11. The fast start-up method of claim 9, wherein the step B comprises:
providing a current limit threshold controlled by the supply voltage so as to determine the maximum of the current through the power switch;
comparing the first sensing signal with the current limit threshold and turning off the power switch when the first sensing signal reaches the current limit threshold, thereby limiting the maximum of the current through the power switch; and
lowering the current limit threshold in accordance with a descending of the supply voltage when the output terminal of the flyback power supply occurs the short circuit, thereby lowering the maximum of the current through the power switch.

12. The fast start-up method of claim 11, wherein the step of providing a current limit threshold controlled by the supply voltage comprises:
providing a first offset current to a threshold value resistor for generating the current limit threshold; and
providing a second offset current to the threshold value resistor when the supply voltage is higher than a preset value, thereby raising the current limit threshold.

13. The fast start-up method of claim 9, wherein the step B comprises:
dividing the first sensing signal via a voltage dividing ratio so as to generate a second sensing signal; wherein, the voltage dividing ratio is controlled by the supply voltage;
comparing the second sensing signal with a current limit threshold and turning off the power switch when the second sensing signal reaches the current limit threshold, thereby limiting the maximum of the current through the power switch; and
adjusting the voltage dividing ratio in accordance with a descending of the supply voltage when the output terminal of the flyback power supply occurs the short circuit, thereby lowering the maximum of the current through the power switch.

14. The fast start-up method of claim 13, wherein the step of dividing the first sensing signal to generate a second sensing signal comprises:
dividing the first sensing signal via a plurality of serially connected resistors so as to generate a plurality of voltage dividing signals; and
selecting the first sensing signal or one of the plurality of voltage dividing signals to be served as the second sensing signal according to the supply voltage.

15. The fast start-up method of claim 9, wherein the step B comprises:
determining an offset voltage according to the supply voltage;
offsetting the first sensing signal according to the offset voltage so as to generate a second sensing signal;
comparing the second sensing signal with a current limit threshold and turning off the power switch when the second sensing signal reaches the current limit threshold, thereby limiting the maximum of the current through the power switch; and
adjusting the offset voltage in accordance with a descending of the supply voltage when the output terminal of the flyback power supply occurs the short circuit, thereby lowering the maximum of the current through the power switch.

16. The fast start-up method of claim 15, wherein, the step of determining an offset voltage according to the supply voltage comprises:
providing a fixed current through a variable resistor so as to generate the offset voltage between two terminals of the variable resistor , wherein the offset voltage is varying with a variation of a resistance of the variable resistor; and
controlling the resistance of the variable resistor according to the supply voltage.
